(19) United States
(12) Patent Application Publication
(10) Pub. No.: US 2026/0297462 A1
(43) Pub. Date: Oct. 1, 2026

(54) POLYMERS, AQUEOUS COMPOSITIONS COMPRISING SUCH POLYMERS, AND USE AS LAUNDRY DETERGENTS

(71) Applicant: BASF SE, Ludwigshafen am Rhein (DE)

(72) Inventors: Helen ROTHER-NOEDING, Ludwigshafen am Rhein (DE); Eva-Maria REIS-WALTHER, Ludwigshafen am Rhein (DE); Jochen Eckhard WILLERSINN, Ludwigshafen am Rhein (DE); Guido VANDERMEULEN, Ludwigshafen am Rhein (DE); Catharina WOHLMUTH, Ludwigshafen am Rhein (DE); Helmut WITTELER, Ludwigshafen am Rhein (DE)

(21) Appl. No.: 19/479,771

(22) PCT Filed: May 6, 2024
(86) PCT No.: PCT/EP2024/062465

§ 371 Date: Oct. 29, 2025

(30) Foreign Application Priority Data
May 16, 2023 (EP) 23173690.1

(51) Int. Cl. C11D 3/37; C08G 69/40; C08J 3/12; C11D 3/386

(52) U.S. Cl. CPC C11D 3/3788; C08G 69/40; C08J 3/126; C11D 3/3707; C11D 3/38636; C08J 2377/04; C08J 2377/06; C08J 2471/02

(57) ABSTRACT

Disclosed herein is an aqueous composition including
(A) at least one polymer including
   (a) a core formed by an aliphatic di-, tri- or tetracarboxylic acid amidated with aliphatic triamine or tetraamine where the amino groups are connected through C₂-C₄-alkylene groups where at least 50 mol-% of the C₂-C₄-alkylene groups are alkylene groups with at least three carbon atoms, and
   (b) poly alkylene oxide chains linked directly to the amino groups of the core or indirectly through a spacer.

The present invention relates to aqueous composition comprising
(A) at least one polymer comprising
   (a) a core formed by an aliphatic di-, tri- or tetracarboxylic acid amidated with aliphatic triamines or tetraamines wherein the amino groups are connected through C₂-C₄-alkylene groups wherein at least 50 mol-% of the C₂-C₄-alkylene groups are alkylene groups with at least three carbon atoms,
   (b) poly alkylene oxide chains linked directly to the amino groups of the core or indirectly through a spacer.

Furthermore, the present invention is directed to polymers (A) useful for such compositions, and to a process for making such polymers (A), and furthermore their manufacture, their uses, particularly for use in cleaning compositions such as laundry detergent compositions, and specifically for improved clay removal in laundry care.

Detergent formulators are continuously faced with the task of developing improved products to remove a broad spectrum of soils and stains from fabrics and hard surfaces. Chemically and physico-chemically, the varieties of soils and stains spectrum range from polar soils, such as proteinaceous, clay, and inorganic soils, to non-polar soils, such as soot, carbon-black, by-products of incomplete hydrocarbon combustion, and organic soils like sebum.

Clay stains are still a challenge in laundering. Said challenge may be associated with the high degree of surface charge density associated with the clay itself. This high surface charge density may act to repel some laundry ingredients. Thus, surfactants alone cannot remove or carry away the clay into the laundry liquor. Furthermore, to date no enzyme technology is available to achieve satis-factory cleaning benefits on this type of soil. Although numerous suggestions for clay removal have been made—polymers, enzymes, surfactants—solutions that work well are still of interest.

Furthermore, one of the most important targets of the detergent and cleaner (D&C) industry today is the need for biodegradability, thus, to improve the sustainability of the detergent formulations and to avoid the potential accumulation of ingredients or their degradation products resulting from incomplete biodegradation of the polymers in the ecosystem. It is thus required to lower the persistence in nature after usage of the laundry detergents and of their ingredients. Hence, there is a strong need for new biodegradable cleaning polymers that provide both excellent primary (i.e., soil removal) and secondary (i.e., whiteness maintenance) cleaning benefits and an improved biodegradability.

Ideally, the polymers are readily biodegradable, i.e., show equal to or more than 60% oxygen consumption after 28 days in the OECD 301 F test or at least show equal to or more than 60% after 56 days in the OECD 301 F test. Alternatively, polymers are inherently biodegradable in the OECD 302B test, i.e., show equal to or more than 70% dissolved organic carbon (DOC) levels. Hence, there was a need to find polymer architectures with a superior performance profile, a feasible prepa-ration process and an improved biodegradation behavior.

Accordingly, the aqueous compositions defined at the outset have been found, hereinafter also referred to as inventive (aqueous) compositions or compositions according to the present invention. Inventive compositions contain at least one polymer (A) that comprises several building blocks:
(a) a core formed by an aliphatic di-, tri- or tetracarboxylic acid amidated with aliphatic triamines or tetraamines wherein the amino groups are connected through C₂-C₄-alkylene groups wherein at least 50 mol-% of the C₂-C₄-alkylene groups are alkylene groups with at least three carbon atoms,
(b) poly alkylene oxide chains linked directly to the amino groups of the core or indirectly through a spacer.

The term “aqueous compositions” refers to compositions that are liquid at ambient temperatures and whose main solvent is water. Preferably, less than 10% by vol of the solvent is a solvent other than water, for example 1,2-propylene glycol, ethylene glycol, or diethylene glycol.

Preferably, inventive compositions are laundry compositions or detergent compositions.

Inventive aqueous compositions contain at least one polymer (A) that shall be described in more detail below. Polymer (A) contains a core (a), in the context of the present invention also referred to as (a), and poly alkylene oxide chains (b), also referred to as (b).

In one embodiment of the present invention, inventive compositions contain in the range of from 0.1 to 10% by weight of polymer (A), referring to the solids content of the respective aqueous composition, preferred are 1.0 to 5.0% by weight. The solids content may be determined by evaporation of all volatiles at a temperature of 100° C. in vacuo until the weight remains constant for at least 30 minutes.

Core (a) is formed by an aliphatic di-, tri- or tetracarboxylic acid, preferably a di- or tricarboxylic acid. Said aliphatic di-, tri- or tetracarboxylic acid may bear 3 to 8 carbon atoms, whereas tetracarboxylic acids need to have at least 6 carbon atoms, preferred are di- and tricarboxylic acids with 4 to 6 carbon atoms. Said aliphatic di-, tri- or tetracarboxylic acid may bear the carboxylic acid groups as sole functional groups, or it may bear functional groups other than carboxylic acid groups, especially secondary or tertiary hydroxyl groups. Examples are adipic acid, glutamic acid, tartaric acid, malic acid, propane-1,2,3-tricarboxylic acid, citric acid, sebacic acid, succinic acid, butane 1,2,3,4-tetracarboxylic acid, and malonic acid, preferred examples are adipic acid, glutamic acid, tartaric acid, malic acid and citric acid.

Said aliphatic di-, tri- or tetracarboxylic acid is amidated with aliphatic triamine or tetraamine wherein the amino groups are connected through C₂-C₄-alkylene groups wherein at least 50 mol-% of the C₂-C₄-alkylene groups are alkylene groups with at least three carbon atoms. Although it is possible to achieve a complete amidation with no free carboxylic acid groups remaining it may occur that up to 10 mol-%, preferably only up to 5 mol-% of the carboxylic acid groups remain unreacted. Amidation may occur in each case by a secondary and preferably by a primary amino group.

Examples of suitable triamines are N3-amine (2-aminoethyl-1,3-propanediamine), 2-aminoethyl-1,4-butanediamine, 2-aminopropyl-1,4-butanediamine, diethylene triamine (“DETA”) and combinations of at least two of the foregoing. Examples of suitable tetramines are N4-amine (N,N′-bis(3-aminopropyl)-1,2-ethylenediamine), 1,2-(ω-aminobutyl)-1,2-ethylendiamine, H₂N—(CH₂)₃—NH—(CH₂)₄—NH—(CH₂)₃—NH₂, triethylene tetraamine (“TETA”), and preferred aliphatic triamines or tetraamines are selected from N,N′-bis(3-aminopropyl)-1,3-propanediamine, N4-amine, N3-amine and combinations of N3-amine and N4-amine, and combinations of at least two of the foregoing.

The above amine(s) may be combined with a diamine, especially an aliphatic diamine, for example 1,3-propylendiamine and 1,2-ethylendiamine. In such combinations, however, the majori-ty of the alkylene groups bear 3 or 4 carbon atoms.

Preferably, aliphatic triamines or tetraamines are selected from N4-amine, N3-amine and combinations of N3-amine and N4-amine, for example in a molar ratio in the range of from 1:100 to 1:25.

Under amidation reaction conditions, preferably up to 5 mol-&% of the secondary or tertiary hydroxyl groups may react, for example in tartaric acid or citric acid.

Core (a) may have an amino number in the range of from 400 to 1200 mg KOH/g, preferably 500 to 800 mg KOH/g.

Polymer (A) further comprises poly alkylene oxide chains (b), hereinafter also referred to as polyalkylene oxide chains.

Poly alkylene oxide chains (b)—or polyalkylene oxide in chains (b)—is selected from addition polymers of ethylene oxide (“EO”), 1,2-propylene oxide (“PO”) or 1,2-butylene oxide (“BuO”) or combinations of at least two of the aforementioned. Preferably, in such poly alkylene oxide chains, at least 50 mol-% of the alkylene oxide is selected from ethylene oxide, more preferably at least 60 mol-%. In a particularly preferred embodiment, polyalkylene glycol is polyethylene glycol. Such side chains (b) are bonded to the amino group of the amine building blocks and to the OH-groups of the carboxylic acid building blocks of core (a).

Preferably, polymer (A) bears 3 to 70 alkylene oxide groups per alkoxylated site on a nitrogen or oxygen atom—thus, —N(AO)ₓ₁ or —O(AO)ₓ₁— with AO being alkylene oxide selected from EO, PO, BuO and combinations, or —N[(AO)ₓ₁]₂ with x1 being in the range of from 3 to 70. Those are examples wherein a polyalkylene oxide chain is directly linked to an amino group.

In one embodiment of the present invention, polymer (A) bears 3 to 70 EO groups per alkoxylated site on a nitrogen or oxygen atom, preferably 4 to 25. In another embodiment of the present invention, polymer (A) bears a combination of EO and PO groups, for example 20 to 30 EO groups and 15 to 30 PO groups. Examples of specific polyalkylene oxide chains are -EO₂₀—PO₂₀, EO₂₄—PO₁₆, EO₁₆—PO₂₄, and EO₃₀—PO₃₀.

Said chains may be capped, for example with a methyl or ethyl group, or non-capped.

In another embodiment, the polyalkylene oxide chains (b) are linked to the amino groups through a spacer.

In one embodiment of the present invention, spacers are selected from a CH₂—CH(X¹)C═O-group, with X¹ being selected from hydrogen and methyl, and from a CH₂—C═O group. In one embodiment of the present invention, the weight ratio of core (a) to side chains (b) is in the range of from 1:5 to 1:2.

In one embodiment of the present invention, spacers are selected from O—(CH₂)₅—C═O or
O—(CH₂)₃—C═O groups, and from —O—(CH₂)₅—C(═O)—O—(CH₂)₅—C(═O)— or
—O—(CH₂)₃—C(═O)—O—(CH₂)₃—C(═O)— groups. They may be introduced by converting core (a) with ε-caprolactone or γ-butyrolactone.

In one embodiment of the present invention, inventive formulations contain certain amounts of C₂-C₃-alkenyl poly-C₂-C₃-alkylene glycol, for example vinyl polyethylene glycol or allyl poly-C₂-C₃-alkylene glycol—thus, poly-C₂-C₃-alkylene glycol capped with an CH2═CH—CH2-O—, group. Preferred is vinyl-polyethylene glycol. Said C₂-C₃-alkenyl poly-C₂-C₃-alkylene glycol may be formed during the synthesis of polymer (A), especially if made by alkoxylation, see path (γ2) of the inventive process, vide infra. It is in many instances difficult to remove C₂-C₃-alkenyl poly-C₂-C₃-alkylene such as vinyl-polyethylene from polymer (A). It is preferred to not remove C₂-C₃-alkenyl poly-C₂-C₃-alkylene such as vinyl-polyethylene from polymer (A). When said impurity is present it is more accurate to characterize polymer (A)—including impurity of C₂-C₃-alkenyl poly-C₂-C₃-alkylene such as vinyl-polyethylene glycol—by way of amine numbers rather than by way of average molecular weight. In the context of the present invention, amine numbers of polymer (A) refer to the polymer (A) with impurity, if applicable.

Impurities of C₂-C₃-alkenyl poly-C₂-C₃-alkylene such as vinyl-polyethylene glycol may be detect-ed by ¹H NMR spectroscopy.

Without wishing to be bound by any theory, we believe that the amount of C₂-C₃-alkenyl poly-C₂-C₃-alkylene such as vinyl-polyethylene glycol may amount to up to 30% by weight of polymer (A).

In one embodiment of the present invention, polymers (A) have an amine value in the range of from 10 to 100 mg KOH/g, determined according to DIN EN ISO 9702 (1998), preferably 20 to 70 mg KOH/g. The amine value refers to the sum of primary, secondary and tertiary amines.

Inventive compositions may comprise impurities that stem from the synthesis of polymer (A), for example polyalkylene oxide of which at least 50 mol-% of the alkylene oxide groups are ethylene oxide groups.

In one embodiment of the present invention, inventive compositions comprise at least one enzyme, in brief also enzyme (B).

Preferably, such enzyme (B) is selected from the list consisting of hydrolases, proteases, amylases, lipases, cellulases, hemicellulases, phospholipases, esterases, DNases, mannanases, xylanases, dispersins, oxidoreductases, cutinases, pectate lyases, pectinases, lactases and peroxidases, and combinations of at least two of the foregoing types, more preferably at least one enzyme being selected from proteases, is present—additionally for improvement of removal of oily/fatty stains, food stain removal and/or removal of complex stains

Any enzyme according to the invention relates to parent enzymes and/or variant enzymes, both having enzymatic activity. Enzymes having enzymatic activity are enzymatically active or exert enzymatic conversion, meaning that enzymes act on substrates and convert these into products. The term “enzyme” herein excludes inactive variants of an enzyme.

A “parent” sequence (of a parent protein or enzyme, also called “parent enzyme”) is the starting sequence for introduction of changes (e.g., by introducing one or more amino acid substitutions, insertions, deletions, or a combination thereof) to the sequence, resulting in “variants” of the parent sequences. The term parent enzyme (or parent sequence) includes wild-type enzymes (sequences) and synthetically generated sequences (enzymes) which are used as starting sequences for introduction of (further) changes.

The term “enzyme variant” or “sequence variant” or “variant enzyme” refers to an enzyme that differs from its parent enzyme in its amino acid sequence to a certain extent. If not indicated otherwise, variant enzyme “having enzymatic activity” means that this variant enzyme has the same type of enzymatic activity as the respective parent enzyme.

In one embodiment of the present invention, inventive compositions comprise
(B) at least one hydrolase, hereinafter also referred to as hydrolase (B), preferably selected from hydrolases, hereinafter also referred to as hydrolase (B).

In one embodiment, hydrolases (B) are selected from proteases, amylases, lipases, cellulases, and mannanases.

In one embodiment of the present invention, inventive compositions comprise
(B) at least one protease (B), hereinafter also referred to as protease (B).

In one embodiment of the present invention, inventive compositions comprise
(C) at least one anionic surfactant, hereinafter also being referred to as anionic surfactant (C).

Examples of anionic surfactants (C) are alkali metal and ammonium salts of C₈-C₁₈-alkyl sulfates, of C₈-C₁₈-fatty alcohol polyether sulfates, of sulfuric acid half-esters of ethoxylated C₄-C₁₂-alkylphenols (ethoxylation: 1 to 50 mol of ethylene oxide/mol), C₁₂-C₁₃ sulfo fatty acid alkyl esters, for example of C₁₂-C₁₃ sulfo fatty acid methyl esters, furthermore of C₁₂-C₁₃-alkylsulfonic acids and of C₁₀-C₁₈-alkylarylsulfonic acids. Preference is given to the alkali metal salts of the aforementioned compounds, particularly preferably the sodium salts.

Further examples of anionic surfactants (C) are soaps, for example the sodium or potassium salts of stearic acid, oleic acid, palmitic acid, ether carboxylates, and alkylether phosphates.

In a preferred embodiment of the present invention, anionic surfactant (C) is selected from compounds according to general formula (I)

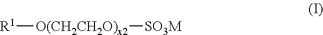

wherein
R¹ n-C₁₀-C₁₈-alkyl, especially with an even number of carbon atoms, for example n-decyl, n-dodecyl, n-tetradecyl, n-hexadecyl, or n-octadecyl, preferably C₁₀-C₁₄-alkyl, and even more preferably n-C₁₂-alkyl,
X2 being a number in the range of from 1 to 5, preferably 2 to 4 and even more preferably 3.
M being selected from alkali metals, preferably potassium and even more preferably sodium.

In anionic surfactant (C), x2 may be an average number and therefore n is not necessarily a whole number, while in individual molecules according to formula (Ill a), x denotes a whole number.

In one embodiment of the present invention, inventive compositions may contain 0.1 to 60% by weight of anionic surfactant (C), preferably 5 to 50% by weight.

Inventive compositions may comprise ingredients other than the aforementioned. Examples are non-ionic surfactants, fragrances, dyestuffs, biocides, preservatives, enzymes, hydrotropes, builders, viscosity modifiers, polymers, buffers, defoamers, and anti-corrosion additives.

Preferred inventive compositions may contain one or more non-ionic surfactants.

Preferred non-ionic surfactants are alkoxylated alcohols, di- and multiblock copolymers of ethylene oxide and propylene oxide and reaction products of sorbitan with ethylene oxide or propylene oxide, alkyl polyglycosides (APG), hydroxyalkyl mixed ethers and amine oxides.

Preferred examples of alkoxylated alcohols and alkoxylated fatty alcohols are, for example, compounds of the general formula (II)

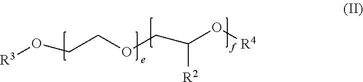

in which the variables are defined as follows:
R² is identical or different and selected from hydrogen and linear C₁-Coo-alkyl, preferably in each case identical and ethyl and particularly preferably hydrogen or methyl,
R³ is selected from C₈-C₂₂-alkyl, branched or linear, for example n-C₈H₁₇, n-C₁₀H₂₁, n-C₁₂H₂₅, n-C₁₄H₂₉, n-C₁₆H₃₃ or n-C₁₈H₃₇,
R⁴ is selected from C₁-C₁₀-alkyl, methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl or isodecyl,

The variables e and f are in the range from zero to 300, where the sum of e and f is at least one, preferably in the range of from 3 to 50. Preferably, e is in the range from 1 to 100 and f is in the range from 0 to 30.

In one embodiment, compounds of the general formula (II) may be block copolymers or random copolymers, preference being given to block copolymers.

Other preferred examples of alkoxylated alcohols are, for example, compounds of the general formula (III)

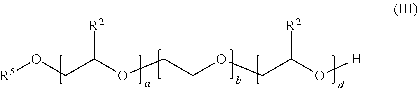

in which the variables are defined as follows:
R² is identical or different and selected from hydrogen and linear C₁-C₀-alkyl, preferably identical in each case and ethyl and particularly preferably hydrogen or methyl,
R⁵ is selected from C₆-C₂₀-alkyl, branched or linear, in particular n-C₈H₁₇, n-C₁₀H₂₁, n-C₁₂H₂₅, n-C₁₃H₂₇, n-C₁₅H₃₁, n-C₁₄H₂₉, n-C₁₆H₃₃, n-C₁₈H₃₇,
a is a number in the range from zero to 10, preferably from 1 to 6,
b is a number in the range from 1 to 80, preferably from 4 to 20,
d is a number in the range from zero to 50, preferably 4 to 25.

The sum a+b+d is preferably in the range of from 5 to 100, even more preferably in the range of from 9 to 50.

Compounds of the general formula (III) may be block copolymers or random copolymers, preference being given to block copolymers.

Further suitable nonionic surfactants are selected from di- and multiblock copolymers, com-posed of ethylene oxide and propylene oxide. Further suitable nonionic surfactants are selected from ethoxylated or propoxylated sorbitan esters. Amine oxides or alkyl polyglycosides, especially linear C₄-C₁₆-alkyl polyglucosides and branched C₈-C₁₄-alkyl polyglycosides such as compounds of general average formula (IV) are likewise suitable.

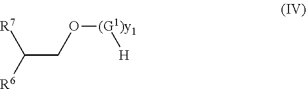

wherein:
R⁶ is C₁-C₄-alkyl, in particular ethyl, n-propyl or isopropyl,
R⁷ is —(CH₂)₂—R⁶,
G¹ is selected from monosaccharides with 4 to 6 carbon atoms, especially from glucose and xylose,
y1 in the range of from 1.1 to 4, y1 being an average number,

Further examples of non-ionic surfactants are compounds of general formula (V) and (VI)

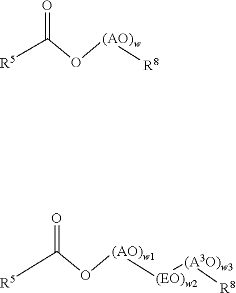

AO is selected from ethylene oxide, propylene oxide and butylene oxide,
EO is ethylene oxide, CH₂CH₂—O,
R⁸ selected from C₈-C₁₈-alkyl, branched or linear, and R⁵ is defined as above.
A³O is selected from propylene oxide and butylene oxide,
w is a number in the range of from 15 to 70, preferably 30 to 50,
w1 and w3 are numbers in the range of from 1 to 5, and
w2 is a number in the range of from 13 to 35.

An overview of suitable further nonionic surfactants can be found in EP-A 0 851 023 and in DE-A 198 19 187.

Mixtures of two or more different nonionic surfactants selected from the foregoing may also be present.

Other surfactants that may be present are selected from amphoteric (zwitterionic) surfactants and anionic surfactants and mixtures thereof.

Examples of amphoteric surfactants are those that bear a positive and a negative charge in the same molecule under use conditions. Preferred examples of amphoteric surfactants are so-called betaine-surfactants. Many examples of betaine-surfactants bear one quaternized nitrogen atom and one carboxylic acid group per molecule. A particularly preferred example of amphoteric surfactants is cocamidopropyl betaine (lauramidopropyl betaine).

Examples of amine oxide surfactants are compounds of the general formula (VII)

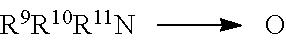

wherein R⁹, R¹⁰, and R¹¹ are selected independently from each other from aliphatic, cycloali-phatic or C₂-C₄-alkylene C₁₀-C₂₀-alkylamido moieties. Preferably, R⁹ is selected from C₈-C₂₀-alkyl or C₂-C₄-alkylene C₁₀-C₂₀-alkylamido and R¹⁰ and R¹¹ are both methyl.

A particularly preferred example is lauryl dimethyl aminoxide, sometimes also called lauramine oxide. A further particularly preferred example is cocamidylpropyl dimethylaminoxide, sometimes also called cocamidopropylamine oxide.

In one embodiment of the present invention, inventive compositions may contain 0.1 to 60% by weight of at least one surfactant, selected from non-ionic surfactants, amphoteric surfactants and amine oxide surfactants.

In a preferred embodiment, inventive solid detergent compositions for cleaners and especially those for automatic dishwashing do not contain any anionic surfactant.

Inventive compositions may contain at least one bleaching agent, also referred to as bleach. Bleaching agents may be selected from chlorine bleach and peroxide bleach, and peroxide bleach may be selected from inorganic peroxide bleach and organic peroxide bleach. Preferred are inorganic peroxide bleaches, selected from alkali metal percarbonate, alkali metal perborate and alkali metal persulfate.

Examples of organic peroxide bleaches are organic percarboxylic acids, especially organic percarboxylic acids.

In inventive compositions, alkali metal percarbonates, especially sodium percarbonates, are preferably used in coated form. Such coatings may be of organic or inorganic nature. Examples are glycerol, sodium sulfate, silicate, sodium carbonate, and combinations of at least two of the foregoing, for example combinations of sodium carbonate and sodium sulfate.

Suitable chlorine-containing bleaches are, for example, 1,3-dichloro-5,5-dimethylhydantoin, N-chlorosulfamide, chloramine T, chloramine B, sodium hypochlorite, calcium hypochlorite, magnesium hypochlorite, potassium hypochlorite, potassium dichloroisocyanurate and sodium dichloroisocyanurate.

Inventive compositions may comprise, for example, in the range from 3 to 10% by weight of chlorine-containing bleach.

Inventive compositions may comprise one or more bleach catalysts. Bleach catalysts can be selected from bleach-boosting transition metal salts or transition metal complexes such as, for example, manganese-, iron-, cobalt-, ruthenium- or molybdenum-salen complexes or carbonyl complexes. Manganese, iron, cobalt, ruthenium, molybdenum, titanium, vanadium and copper complexes with nitrogen-containing tripod ligands and also cobalt-, iron-, copper- and ruthenium-amine complexes can also be used as bleach catalysts.

Inventive compositions may comprise one or more bleach activators, for example N-methylmorpholinium-acetonitrile salts (“MMA salts”), trimethylammonium acetonitrile salts, N-acylimides such as, for example, N-nonanoylsuccinimide, 1,5-diacetyl-2,2-dioxohexahydro-1,3,5-triazine (“DADHT”) or nitrile quats (trimethylammonium acetonitrile salts).

Further examples of suitable bleach activators are tetraacetylethylenediamine (TAED) and tetraacetylhexylenediamine.

Examples of fragrances are benzyl salicylate, 2-(4-tert.-butylphenyl) 2-methylpropional, commercially available as Lilial@, and hexyl cinnamaldehyde.

Examples of dyestuffs are Acid Blue 9, Acid Yellow 3, Acid Yellow 23, Acid Yellow 73, Pigment Yellow 101, Acid Green 1, Solvent Green 7, and Acid Green 25.

Inventive compositions may contain one or more preservatives or biocides. Biocides and preservatives prevent alterations of inventive liquid detergent compositions due to attacks from microorganisms. Examples of biocides and preservatives are BTA (1,2,3-benzotriazole), benzalkonium chlorides, 1,2-benzisothiazolin-3-one (“BIT”), 2-methyl-2H-isothiazol-3-one (“MIT”) and 5-chloro-2-methyl-2H-isothiazol-3-one (“CIT”), benzoic acid, sorbic acid, iodopropynyl butyl-carbamate (“IPBC”), dichlorodimethylhydantoine (“DCDMH”), bromochlorodimethylhydantoine (“BCDMH”), and dibromodimethylhydantoine (“DBDMH”).

Examples of biocides that are particularly of interest are the following antimicrobial agents and/or preservatives:
4,4′-dichloro 2-hydroxydiphenyl ether (CAS-No. 3380-30-1), further names: 5-chloro-2-(4-chlorophenoxy) phenol, Diclosan, DCPP, which is commercially available as a solution of 30 wt % of 4,4′-dichloro 2-hydroxydiphenyl ether in 1,2 propyleneglycol under the trade name Tinosan® HP 100;
and
2-Phenoxyethanol (CAS-no. 122-99-6, further names: Phenoxyethanol, methylphenylglycol, phenoxetol, ethylene glycol phenyl ether, ethylene glycol monophenyl ether, Protectol® PE);
2-bromo-2-nitropropane-1,3-diol (CAS-No. 52-51-7, further names: 2-bromo-2-nitro-1,3-propanediol, Bronopol@, Protectol® BN, Myacide AS);
Glutaraldehyde (CAS-No. 111-30-8, further names: 1-5-pentandial, pentane-1,5-dial, glutaral, glutardialdehyde, Protectol® GA, Protectol® GA 50, Myacide® GA);
Glyoxal (CAS No. 107-22-2; further names: ethandial, oxylaldehyde, 1,2-ethandial, Protectol® GL);
2-butyl-benzo[d]isothiazol-3-one (BBIT, CAS No. 4299-07-4); 2-methyl-2H-isothiazol-3-one (MIT, CAS No 2682-20-4); 2-octyl-2H-isothiazol-3-one (OIT, CAS No. 26530-20-1); 5-Chloro-2-methyl-2H-isothiazol-3-one (CIT, CMIT, CAS No. 26172-55-4); mixtures of 5-chloro-2-methyl-2H-isothiazol-3-one (CMIT, EINECS 247-500-7) and 2-methyl-2H-isothiazol-3-one (MIT, EINECS 220-239-6) (Mixture of CMIT/MIT, CAS No. 55965-84-9); 1,2-benzisothiazol-3(2H)-one (BIT, CAS No. 2634-33-5);
Hexa-2,4-dienoic acid (Sorbic acid, CAS No. 110-44-1) and its salts, e.g., calcium sorbate, sodium sorbate, Potassium (E,E)-hexa-2,4-dienoate (Potassium Sorbate, CAS No. 24634-61-5);
Lactic acid and its salts; especially sodium lactate,
L-(+)-lactic acid (CAS No. 79-33-4);
Benzoic acid (CAS No 65-85-0, CAS No. 532-32-1) and salts of benzoic acid, e.g., sodium benzoate, ammonium benzoate, calcium benzoate, magnesium benzoate, MEA-benzoate, potassium benzoate;
Salicylic acid and its salts, e.g., calcium salicylate, magnesium salicylate, MEA salicylate, sodium salicylate, potassium salicylate, TEA salicylate; Benzalkonium chloride, benzalkonium bro-mide, benzalkonium saccharinate (CAS Nos 8001-54-5, 63449-41-2, 91080-29-4, 68989-01-5, 68424-85-1, 68391-01-5, 61789-y71-7, 85409-22-9);
Didecyldimethylammonium chloride (DDAC, CAS No. 68424-95-3 and CAS No. 7173-51-5);
N-(3-aminopropyl)-N-dodecylpropane-1,3-diamine (Diamine, CAS No. 2372-82-9);
Peracetic acid (CAS No. 79-21-0);
Hydrogen peroxide (CAS No. 7722-84-1);
Biocide or preservative may be added to the inventive composition in a concentration of 0.001 to 10% relative to the total weight of the composition. Preferably, inventive compositions contain 2-phenoxyethanol in a concentration of 0.1 to 2% or 4,4′-dichloro 2-hydroxydiphenyl ether (DCPP) in a concentration of 0.005 to 0.6%.

The invention thus further pertains to a method of preserving an inventive composition against microbial contamination or growth, which method comprises addition of 2-phenoxyethanol.

The invention thus further pertains to a method of providing an antimicrobial effect on textiles after treatment with an inventive composition containing 4,4′-dichloro 2-hydroxydiphenyl ether (DCPP).

Examples of viscosity modifiers are agar-agar, carragene, tragacanth, gum arabic, alginates, pectins, hydroxyethyl cellulose, hydroxypropyl cellulose, starch, gelatin, locust bean gum, cross-linked poly(meth)acrylates, for example polyacrylic acid cross-linked with bis-(meth)acrylamide, furthermore silicic acid, clay such as—but not limited to—montmorillonite, zeolite, dextrin, and casein.

Hydrotropes in the context with the present invention are compounds that facilitate the dissolu-tion of compounds that exhibit limited solubility in water. Examples of hydrotropes are organic solvents such as ethanol, isopropanol, ethylene glycol, 1,2-propylene glycol, and further organic solvents that are water-miscible under normal conditions without limitation. Further examples of suitable hydrotropes are the sodium salts of toluene sulfonic acid, of xylene sulfonic acid, and of cumene sulfonic acid.

Inventive compositions may contain at least one polymer other than polymer (A).

Examples of polymers other than polymer (A) are especially polyacrylic acid and its respective alkali metal salts, especially its sodium salt. A suitable polymer is in particular polyacrylic acid, preferably with an average molecular weight M, in the range from 2,000 to 40,000 g/mol. preferably 2,000 to 10,000 g/mol, in particular 3,000 to 8,000 g/mol, each partially or fully neutral-ized with alkali, especially with sodium. Suitable as well are copolymeric polycarboxylates, in particular those of acrylic acid with methacrylic acid and of acrylic acid or methacrylic acid with maleic acid and/or fumaric acid. Polyacrylic acid and its respective alkali metal salts may serve as soil anti-redeposition agents. Further examples are copolymer of acrylic acid with comono-mers bearing a sulfonic acid group, especially AMPS (2-acrylamido-2-methylpropane sulfonic acid) and its sodium salt.

Further examples of polymers other than polymer (A) are polyvinylpyrrolidones (PVP). Polyvinylpyrrolidones may serve as dye transfer inhibitors.

Polymers other than polymer (A) may include, without limitation, “multifunctional alkoxylated polyethylene imines” (for example BASF's Sokalan® HP20), “multifunctional alkoxylated diamines” (for example BASF's Sokalan® HP96) and also terephthalic acid-based polyesters like BASF's Sokalan® SR100 and Clariant's TexCare®, such as TexCare® SRN 170, TexCare@SRN 172, TexCare® SRN 260, TexCare® SRN 260 SG Terra and TexCare® SRA 300 as well as distinct combinations of all of the before mentioned polymers.

Suitable multifunctional alkoxylated polyethylene imines are typically ethoxylated polyethylene imines with a weight-average molecular weight M, in the range from 3000 to 250000, preferably 5000 to 200,000, more preferably 8000 to 100,000, even more preferably 8000 to 50000, even more preferably 10000 to 30000, and most preferably 10000 to 20000 g/mol. Suitable multifunctional ethoxylated polyethylene imines bear 80 wt.-% to 99 wt.-%, preferably 85 wt.-% to 99 wt.-%, more preferably 90 wt.-% to 98 wt.-%, most preferably 93 wt.-% to 97 wt.-% or 94 wt.-% to 96 wt.-% ethylene oxide side chains, based on the total weight of the respective polymer other than polymer (A). Ethoxylated polyethylene imines are typically based on a polyethylene imine core and a polyethylene oxide shell. Suitable polyethylene imine cores are polyethylene imines with a weight-average molecular weight M, in the range of 500 to 5000 g/mol. Preferably employed is a molecular weight from 500 to 1000 g/mol, even more preferred is a M_{w} of 600 to 800 g/mol. The ethoxylated polyethylene imines then have on average 5 to 50, preferably 10 to 35 and even more preferably 20 to 35 ethylene oxide (EO) units per NH-functional group. Average molecular weights of alkoxylate d and especially ethoxylated polyethylene imines may be determined by gel permeation chromatography (GPC), for example with 0.1 M aqueous formic acid or with a 0.05% by weight potassium trifluoroacetate in hexafluoroisopro-panol as mobile phase.

Suitable multifunctional alkoxylated diamines are typically ethoxylated C₂-C₁₂-alkylene diamines, preferably hexamethylene diamine, which are further quaternized and optionally sulfated. Typical multifunctional alkoxylated diamines have a weight-average molecular weight M, in the range from 2000 to 10000, more preferably 3000 to 8000, and most preferably 4000 to 6000 g/mol. In a preferred embodiment of the invention, ethoxylated hexamethylene diamine, furthermore quaternized and sulfated, may be employed, which contain on average 10 to 50, preferably 15 to 40 and even more preferably 20 to 30 ethylene oxide (EO) groups per NH-functional group, and which preferably bear two cationic ammonium groups and two anionic sulfate groups per molecule.

Further examples of polymers are polyethylene terephthalates, polyoxyethylene terephthalates, and polyethylene terephthalates that are end-capped with one or two hydrophilic groups per molecule, hydrophilic groups being selected from CH₂CH₂CH₂—SO₃Na, CH₂CH(CH₂—SO₃Na)₂, and CH₂CH(CH₂SO₂Na)CH₂—SO₃Na.

Examples of buffers are monoethanolamine and N,N,N-triethanolamine. Examples of defoamers are silicones.

Inventive compositions are not only good in cleaning soiled laundry with respect to clay soiling. Inventive liquid detergent compositions are very useful for removing bleachable stains such as, but not limited to stains from red wine, tea, coffee, vegetables, and various fruit juices like berry juices from laundry. They still do not leave residues on the clothes. In particular, inventive compositions work in cleaning laundry soiled with clay already at low temperatures, e.g., from 25 to 35° C.

Examples of inventive formulations are summarized in Table A.

TABLE A
Liquid laundry frame formulations according to the invention

| active | | | | | | |
|---|---|---|---|---|---|---|
| (numbers: % active) | F1 | F2 | F3 | F4 | F5 | F6 |
| alcohol ethoxylate 7EO | 5.40 | 10.80 | 12.40 | 7.30 | 1.60 | 7.60 |
| Coco fatty acid K12-18 | 2.40 | 3.10 | 3.20 | 3.20 | 3.50 | 6.40 |
| Fatty alcohol ether sulphate | 5.40 | 8.80 | 7.10 | 7.10 | 5.40 | 14.00 |
| Linear alkyl benzene | 5.50 | 0.00 | 14.50 | 15.50 | 10.70 | 0.00 |
| sulphonic acid | | | | | | |
| 1,2 Propane diol | 6.00 | 3.50 | 8.70 | 8.70 | 1.10 | 7.80 |
| Monoethanolamine | | | 4.00 | 4.30 | 0.30 | |
| NaOH | 2.20 | 1.10 | | | | 1.00 |
| Glycerol | | 0.80 | 3.00 | 2.80 | | |
| Ethanol | 2.00 | | | | 0.38 | 0.39 |
| Na citrate | 3.00 | 2.80 | 3.40 | 2.10 | 7.40 | 5.40 |
| Inventive polymer (A) | 0.1-5 | 0.1-5 | 0.1-5 | 0.1-5 | 0.1-5 | 0.1-5 |
| Protease | 0-1 | 0-1 | 0-1 | 0-1 | 0-1 | 0-1 |
| Amylase | 0-0.5 | 0-0.5 | 0-0.5 | 0-0.5 | 0-0.5 | 0-0.5 |
| Cellulase | 0-0.3 | 0-0.3 | 0-0.3 | 0-0.3 | 0-0.3 | 0-0.3 |
| Lipase | 0-0.2 | 0-0.2 | 0-0.2 | 0-0.2 | 0-0.2 | 0-0.2 |
| Mannanase | 0-0.2 | 0-0.2 | 0-0.2 | 0-0.2 | 0-0.2 | 0-0.2 |
| Pectat Lyase | 0-0.3 | 0-0.3 | 0-0.3 | 0-0.3 | 0-0.3 | 0-0.3 |
| water | to 100 | to 100 | to 100 | to 100 | to 100 | to 100 |

A further aspect of the present invention is therefore the use of inventive compositions for laundry care. Laundry care in this context includes laundry cleaning.

A further aspect of the present invention is related to polymers (A), hereinafter also referred to as inventive polymers or inventive polymers (A). Inventive polymers (A) have been described in detail above.

Within another embodiment, polymers (A) exhibit at least 20%, preferably at least 40% or more preferably at least 60% biodegradability according to standard OECD 301 F within 56 days, preferably within 28 days. More ideally, polymers (A) are readily biodegradable, i.e., show equal to or more than 60% oxygen consumption after 28 days in the OECD 301 F test or at least show equal to or more than 60% after 56 days in the OECD 301 F test. Alternatively, polymers (A) are inherently biodegradable in the OECD 302B test, i.e., show equal to or more than 70% dissolved organic carbon (DOC) levels.

Inventive polymers (A) are excellently suited for making inventive aqueous solutions. In addition, inventive polymers (A) may be formulated in pouches, for example in pouches made from a polymer film such as, but not limited to polyvinylalcohol. In such pouches, inventive polymer may be present as solution in diethylene glycol, triethylene glycol, in a polyethylene glycol that is liquid at ambient temperature, or 1,2-propylene glycol or the like that each may contain up to 15% by volume of water, preferably up to 10% by volume of water, referring to the sum of the respective glycol and water. For optical purposes, such inventive polymer in a pouch may be combined with a dyestuff.

In one aspect, the invention is directed to a method of improving the cleaning performance of a liquid detergent composition, by adding a polymer (A) according to the invention to a detergent composition preferably comprising at least one protease with our without at least one lipase.

The term “improved cleaning performance” herein may indicate that polymers (A) provide better, i.e., improved, properties in stain removal under relevant cleaning conditions, when compared to the cleaning performance of a detergent composition lacking polymer (A). In one embodiment, “improved cleaning performance” means that the cleaning performance of a detergent comprising polymer (A) and at least one enzyme, preferably at least one hydrolase (B), especially at least one protease (B), is improved when compared to the cleaning performance of a detergent comprising polymer (A) and no enzyme. In one embodiment, “improved cleaning performance” means that the cleaning performance of a detergent comprising polymer (A) and an enzyme, preferably hydrolase (B), more preferably protease (b), is improved when compared to the cleaning performance of a detergent comprising at least one enzyme, preferably at least one hydrolase (B), preferably protease (B) and no polymer (A).

The term “relevant cleaning conditions” herein refers to the conditions, particularly cleaning temperature, time, cleaning mechanics, suds concentration, type of detergent and water hardness, actually used in laundry machines, automatic dish washers or in manual cleaning pro-cesses.

Inventive polymers (A) are excellently suited as and particularly for the manufacture of inventive compositions. Inventive polymers (A) show good biodegradability according to OECD.

A further aspect of the present invention relates to a process for making inventive polymers (A), hereinafter also referred to as inventive process or inventive synthesis. The inventive process comprises step (α) and step (β) and step (γ), preferably either step (γ1) or step (γ2). Steps (α), (β) and (γ) are performed subsequently. Steps (α), (β) and (γ) are described in more detail below.

Steps (α) includes providing an aliphatic di-, tri- or tetracarboxylic acid or its respective C₁-C₂-alkyl ester, preferably an aliphatic C₈-C₁₈-di- or tricarboxylic acid or its respective C₁-C₂-alkyl ester. In C₁-C₂-alkyl esters, one or more carboxylic acid groups may be esterified with one or two different alcohols, preferably, all carboxylic acid groups are esterified with either methanol or ethanol.

Examples of carboxylic acids are adipic acid, glutamic acid, tartaric acid, malic acid, propane-1,2,3-tricarboxylic acid, citric acid, sebacic acid, succinic acid, butane 1,2,3,4-tetracarboxylic acid, and malonic acid, preferred examples are adipic acid, glutamic acid, tartaric acid, malic acid and citric acid.

Examples of respective C₁-C₂-alkyl esters are dimethyl adipate, diethyl adipate, triethyl citrate, dimethyl tartrate, diethyl tartrate, dimethyl glutamate, diethyl glutamate, malic acid dimethyl ester, glutamic acid diethyl ester, dimethyl sebacate, diethyl sebacate, and preferred C₁-C₂-alkyl esters are diethyl adipate, triethyl citrate, diethyl tartrate, dimethyl glutamate, and diethyl glutamate.

Aliphatic di-, tri- or tetracarboxylic acid or its respective C₁-C₂-alkyl ester as provided in step (α) may be provided in bulk or as solution, in bulk being preferred. Suitable solvents are alcohols and hydrocarbon, each with a boiling point of 100° C. or less at ambient pressure (1 bar abs.). Specific examples are methanol, ethanol, cyclohexane, and pentane.

Step (β) includes reacting said di-, tri- or tetracarboxylic acid or its respective C₁-C₂-alkyl ester with at least one aliphatic triamine or tetraamine, thereby forming a core (a).

The reaction of step (β) may be performed by mixing one aliphatic triamine or tetraamine with di-, tri- or tetracarboxylic acid or its respective C₁-C₂-alkyl ester and heating the resultant mixture.

In embodiments wherein free di-, tri- or tetracarboxylic acids are reacted in step (β), higher temperatures are applied than when esters are reacted, for example 160 to 200° C., and water is removed by distillation. In order to avoid oxidation, in such embodiments step (β) is preferably performed under inert gas, for example nitrogen or argon, or under reduced pressure, for example 10 to 500 mbar.

In embodiments wherein C₁-C₂-alkyl esters of di-, tri- or tetracarboxylic acids are reacted, a temperature in the range of from 50 to 80° C., preferably 55 to 75° C. C₁-C₂-alkyl alcohol formed during the reaction may be distilled off, at ambient pressure or preferably under reduced pressure, for example 15 to 500 mbar or starting at ambient pressure and then reducing the pressure.

An advantage of reacting C₁-C₂-alkyl ester of di-, tri- or tetracarboxylic acids is that milder reaction conditions, especially with respect to the temperature, may be applied, and cores (a) with a lower Hazen colour number may be obtained.

The duration of step (β) may be in the range of from 30 minutes to 20 hours, preferably 1 to 10 hours. The reaction is preferably terminated as soon as no more C₁-C₂-alkyl alcohol or water, as the case may be, is distilling off.

Step (β) may be performed with or without a catalyst, without being preferred.

In one embodiment of the present invention, core (a) has an amine value in the range of from 400 to 1200 mg KOH/g, determined according to DIN EN ISO 9702 (1998), preferably 500 to 800 mg KOH/g. The amine value refers to the sum of primary, secondary and tertiary amines.

Step (γ) includes attaching polyalkylene chains to the amino groups by
(γ1) reacting core (a) with at least one C₂-C₄-alkylene oxide, for example EO or PO or BuO, preferably with combinations of EO and PO or BuO or with EO alone, in the absence or presence of a catalyst, with or without introduction of a spacer prior to alkoxylation, or
(γ2) reacting core (a) with a monoacid of poly-C₂-C₃-alkylene glycol or with its C₁-C₂-alkyl ether or with (meth)acrylic acid ester of an oligo- or polyethylene glycol or of an oligo- or polypropylene glycol or of a copolymer of ethylene oxide and propylene oxide.

For step (γ1), examples of C₂-C₄-alkylene oxides are ethylene oxide (“EO”), propylene oxide (“PO”), butylene oxide (“BuO”), and mixtures of at least two of the foregoing, for examples combinations of EO and PO and combinations of EO and BuO, in each case with at least 50% mol-% of EO being preferred. More preferred are combinations of PO and EO, even more preferred is solely EO.

In one embodiment of step (γ1), the weight ratio of C₂-C₄-alkylene oxide and core (a) is in the range of from 2 to 1 up to 100 to 1, preferred are 3 to 1 up to 40 to 1.

In one embodiment of step (γ1), the molar ratio of C₂-C₄-alkylene oxide and N—H function is in the range of from 1:1 to 40:1, preferred are 3:1 to 25:1. Primary amino groups count as two N—H functions. N—H functions of amido groups are neglected in this case.

Step (γ1) is carried out in the absence of preferably in the presence of a catalyst, for example a base or a double-metal cyanide.

In one embodiment of the present invention, step (γ1) is carried out in the presence of a base. Suitable bases such as potassium hydroxide, sodium hydroxide, sodium or potassium alkoxides such as potassium methylate (KOCH₃), potassium tert-butoxide, sodium ethoxide and sodium methylate (NaOCH₃), preferably from potassium hydroxide and sodium hydroxide. Further examples of catalysts are alkali metal hydrides and alkaline earth metal hydrides such as sodium hydride and calcium hydride, and alkali metal carbonates such as sodium carbonate and potassium carbonate. Preference is given to the alkali metal hydroxides, preference being given to potassium hydroxide and sodium hydroxide, and to alkali metal alkoxides, particular preference being given to potassium t-butoxide in t-butanol, sodium n-hexanolate in n-hexanol, and to sodium methanolate in n-nonanol. Typical amounts for the base are from 0.05 to 10% by weight, in particular from 0.5 to 2% by weight, based on the total amount of core (a) and C₂-C₄-alkylene oxide.

No phosphate is preferably used as catalyst.

In one embodiment of the present invention, step (γ1) is carried out in the presence of a double-metal cyanide. Double-metal cyanides, hereinafter also referred to as double metal cyanide compounds or DMC compounds, usually comprise at least two different metals, at least one of them being selected from transition metals and the other one being selected from transition metals and alkali earth metals, and furthermore cyanide counterions. Particularly suitable catalysts for the alkoxylation are double-metal cyanide compounds which contain zinc, cobalt or iron or two thereof. Berlin blue, for example, is particularly suitable.

Preference is given to using crystalline DMC compounds. In a preferred embodiment, a crystalline DMC compound of the Zn—Co type which comprises zinc acetate as further metal salt com-ponent is used as catalyst. Such compounds crystallize in monoclinic structure and have a platelet-like habit.

In one embodiment of the present invention, the inventive synthesis is carried out in the presence of at least one double-metal cyanide selected from hexacyano cobaltates.

Double-metal cyanide compounds can be used as powder, paste or suspension or be moulded to give a moulding, be introduced into mouldings, foams or the like or be applied to mouldings, foams or the like.

Preferably, a DMC catalyst used for step (γ1), based on core (a), is from 5 to 2000 ppm (i.e., mg of catalyst per kg of product), preferably less than 1000 ppm, in particular less than 500 ppm, particularly preferably less than 100 ppm, for example less than 50 ppm or 35 ppm, particularly preferably less than 25 ppm; ppm referring to mass-ppm (parts per million) of core (a).

In one embodiment of step (γ1), the alkoxylation is carried out in two or more sub-steps, for example in two or three sub-steps. In a preferred embodiment of step (γ1), a first sub-step is performed by converting core (a) in aqueous with 0.8 to 1.2 equivalents (moles) of C₂—C-alkylene oxide per N—H-function, followed by further alkoxylation in a non-aqueous medium, e.g., in bulk, and in the presence of a catalyst.

Step (γ1) may be carried out in bulk, embodiment (i), or in an organic solvent, embodiment (ii). In embodiment (i), water can be removed from core (a). Such water removal can be done by heating to a temperature in the range of from 80 to 150° C. under a reduced pressure in the range of from 0.01 to 0.5 bar and distilling off the water.

In one embodiment of the present invention, step (γ1) is carried out at a reaction temperature in the range of from 70 to 200° C. and preferably from 100 to 180° C.

In one embodiment of the present invention, the reaction time of step (γ1) is generally in the range of from 30 minutes to 12 hours.

Examples of suitable organic solvents for embodiment (ii) of step (γ1) are nonpolar and polar aprotic organic solvents. Examples of particularly suitable nonpolar aprotic solvents include aliphatic and aromatic hydrocarbons such as hexane, cyclohexane, toluene and xylene. Examples of particularly suitable polar aprotic solvents are ethers, in particular cyclic ethers such as tetra-hydrofuran and 1,4-dioxane, furthermore N,N-dialkylamides such as dimethylformamide and dimethylacetamide, and N-alkyllactams such as N-methylpyrrolidone. It is as well possible to use mixtures of at least two of the above organic solvents. Preferred organic solvents are xylene and toluene.

In embodiment (ii), the solution obtained in the first step, before or after addition of catalyst and solvent, is dewatered before being subjected to alkylene oxide, said water removal advanta-geously being done by removing the water at a temperature in the range of from 80 to 180° C., preferably 80 to 100° C., and preferably supported by a stream of nitrogen. The subsequent reaction with alkylene oxide may be effected as in embodiment (i). In embodiment (i), inventive polymer (A) is obtained directly in bulk and may be dissolved in water, if desired. In embodiment (ii), for work-up organic solvent is typically replaced by water. Inventive polymer (A) according to the invention may alternatively be isolated in bulk.

An—optional—step of work-up may include the deactivation of catalyst used in step (γ1), in the case of basic catalysts by neutralization.

By carrying out step (γ1), non-capped polyethylene oxide chains are obtained.

In embodiments wherein a spacer is introduced prior to step (γ1), core (a) may be converted with ε-caprolactone or γ-butyrolactone. Said conversion may be carried out, e.g., at 50 to 180° C., in the presence or preferably in the absence of a catalyst. A molar ratio of amino groups in core (a) versus lactone functions in the range of from 1:1 to 1:3 may be applied.

In alternative step (γ2), core (a) is reacted with a monoacid of poly-C₂-C₃-alkylene glycol or with its C₁-C₂-alkyl ether or with (meth)acrylic acid ester of an oligo- or polyethylene glycol or of an oligo- or polypropylene glycol or of a copolymer of ethylene oxide and propylene oxide or with a C₁-C₂-alkyl ether of any of the afore mentioned.

Monoacids of poly-C₂-C₃-alkylene glycol or of its C₁-C₂-alkyl ethers may be obtained by oxidizing the terminal alkoxy group of a poly-C₂-C₃-alkylene glycol, for example in the presence of a Pt-bayed catalyst such as, but not limited to Pt on charcoal. Preferred are monoacids of polyethylene glycol monomethyl ether (“MPEG”).

Monoacid(s) of poly-C₂-C₃-alkylene glycol or of its C₁-C₂-alkyl ethers may be reacted with core (a) at temperatures in the range of from 150 to 200° C., preferably 160 to 200° C.

Preferably, monoacid(s) of poly-C₂-C₃-alkylene glycol or of its C₁-C₂-alkyl ethers are reacted with core (a) without the use of a catalyst.

Preferably, monoacid(s) of poly-C₂-C₃-alkylene glycol or of its C₁-C₂-alkyl ethers are reacted with core (a) at a pressure from ambient pressure to 10 bar.

The duration of said reaction may be in the range of from 1 hour to 24 hours. Solvents may be used, e.g., water, methanol, ethanol, or isopropanol. In other embodiments, the reaction is performed without the use of a solvent.

In one embodiment of the present invention, the ratio of core (a) and of monoacid(s) of poly-C₂-C₃-alkylene glycol or of its C₁-C₂-alkyl ethers is selected in a way that the molar ratio of amino groups and carboxylic acid groups is in the range of from 1:1 to 5:1, preferably 2:1 to 4:1.

(Meth)acrylic acid esters of oligo- or polyethylene glycol or of an oligo- or polypropylene glycol or of a copolymer of ethylene oxide and propylene oxide or of a C₁-C₂-alkyl ether of any of the afore mentioned are known per se. In the context of the present invention, oligo-ethylene glycols are tri- and tetraethylene glycol, and oligo-propylene glycols are tri- and tetrapropylene glycol.

In one embodiment of the present invention, (meth)acrylic acid esters of oligo- or polyethylene glycol or of an oligo- or polypropylene glycol or of a copolymer of ethylene oxide and propylene oxide or of a C₁-C₂-alkyl ether of any of the afore mentioned, in brief “(meth)acrylate(s)”, are reacted with core (a) at temperatures in the range of from 30 to 100° C.

In one embodiment of the present invention, the ratio of core (a) and of (meth)acrylate(s) is selected in a way that the molar ratio of amino groups and C═C-double bonds is in the range of from 1:1 to 1:0.2, preferably 2:1 to 5:1 and more preferably 1:0.3.

Reaction of core (a) with (meth)acrylate(s) may be carried out in the presence of a polymerization inhibitor such as MeHQ (4-methoxy hydroquinone) in order to avoid polymerization of said (meth)acrylate.

In one embodiment, reaction of core (a) and of (meth)acrylate(s) is carried out in bulk. Preferably, especially when the viscosity of core (a) or (meth)acrylate(s) reduces the miscibility, reaction of core (a) and of (meth)acrylate(s) is carried out in a solvent, for example methanol, ethanol, water or water/methanol mixtures or water/ethanol mixtures.

In one embodiment of the present invention, after step (γ) has ended, bleaching can be carried out, for example with peroxide such as H₂O₂.

By the inventive process, inventive polymers (A) are obtained in good yield and sufficient purity.

For work-up, any solvent used if applicable is removed, e.g., by evaporation, for example under reduced pressure. If no solvent is used polymer (A) may be used without further work-up.

The invention is further illustrated by working examples.

General remarks:
Reactions were carried out under nitrogen atmosphere unless expressly noted otherwise.
Percentages refer to % by weight unless expressly stated otherwise.
GPC was carried out with THF as mobile phase, with linear PMMA as internal standard and polystyrene-1,3-divinylbenzene gel as stationary phase
Hydroxyl values (OH values) were determined according to DIN 53240 (2013).
Amine values were determined according to DIN EN ISO 9702 (1998).
rpm: revolutions per minute. NI: norm liter, volume determined at ambient pressure and 23° C.

### I. SYNTHESIS OF INVENTIVE POLYMERS (A)

### I.1 Starting Materials

The following commercially available starting materials were provided:
(α.1) triethylcitrate
(α.2) diethyl L-(+)-tartrate
N,N′-bis(3-aminopropyl)ethylenediamine (N4-amine), contains up to 4 mol-% N,N-bis(3-aminopropyl)ethylenediamine and up to 3 mol-% N3-amine
N,N′-bis(3-aminopropyl)-1,3-propylenediamine

### I.2 Syntheses of Cores (a)

### I.2.1 Synthesis of Core (α.1), Step (β.1)

A one-liter four-neck flask equipped with stirrer and distillation head was charged with 522.9 g (3 mol) of N4-amine. An amount of 276.3 g (1 mol) (α.1) was added over the period of four hours.

The resulting mixture was heated to 60° C. at ambient pressure for four hours. Then, the pressure was reduced and ethanol formed was distilled off. Then, the reaction mixture was cooled to ambient temperature. Core (α.1) was obtained as yellow viscous substance. IR and ¹H NMR showed almost complete conversion to the amide.

### I.2.2 Synthesis of Core (α.2), Step (β3.2)

A one-liter four-neck flask equipped with stirrer and distillation head was charged with 200 g (1.06 mol) of N,N′-bis(3-aminopropyl)-1,3-propylenediamine. An amount of 97.8 g (0.35 mol) (α.1) was added over the period of four hours. The resulting mixture was heated to 60° C. at ambient pressure for four hours. Then, the pressure was reduced and ethanol formed was distilled off. Then, the reaction mixture was cooled to ambient temperature. Core (α.2) was obtained as yellow viscous substance. IR and ¹H NMR showed almost complete conversion to the amide.

### I.2.3 Synthesis of Core (α.3), Step (β3.3)

A two-liter four-neck flask equipped with stirrer and distillation head was charged with 522.9 g (3 mol) of N4-amine. An amount of 412.4 (2 mol eq.) (α.2) was added over the period of four hours. The resulting mixture was heated to 60° C. at ambient pressure for four hours. Then, the pressure was reduced and methanol as well as ethanol formed was distilled off. Water was added during the distillation. Then, the reaction mixture was cooled to ambient temperature. Core (α.3) was obtained as yellow viscous solution (40% by weight). IR and ¹H NMR showed almost complete conversion to the amide.

### I.2.4 Synthesis of Core (α.4), Step (3.4)

A two-liter four-neck flask equipped with stirrer and distillation head was charged with 435.8 g (5 mol-eq.) of N4-amine. An amount of 276.3 g (1 mol, 2 mol-eq) (α.1) was added over the period of four hours. The resulting mixture was heated to 60° C. at ambient pressure for four hours. Then, the pressure was reduced and ethanol formed was distilled off. Then, the reaction mixture was cooled to ambient temperature. Core (α.4) was obtained as a dark yellow viscous substance. IR and ¹H NMR showed almost complete conversion to the amide.

### 1.3 Syntheses of Inventive Polymers

### I.3.1 Synthesis of Inventive Polymer (A.1), Step (γ1.1)

A 2-liter steel autoclave was charged with 100 g core (α.1) and 10 g water and then heated to 100° C. Then, 72 g of ethylene oxide were added within 2 hours (0.9 mol EO/N—H). The start of an exothermic reaction was observed. The resultant mixture was allowed to react for 6 hours. Water was—together with further volatile compounds—removed at reduced pressure (20 mbar) at 90° C. A highly viscous dark red oil (162.4 g) was obtained, of which 95 g were subjected to further ethoxylation: they were mixed in the autoclave with 6.1 g potassium methoxide (32.5% by weight in methanol). The methanol was removed by heating under reduced pressure (20 mbar) to 90° C. for two hours. The autoclave was purged three times with nitrogen and then heated to 120° C. An amount of 847 g of EO were added within 15 hours, total amount of EO: 20 mol/N—H. The mixture was stirred at 120° C. for further 6 hours. Residual EO and water were stripped under reduced pressure (20 mbar) at 90° C. 940.7 g of inventive polymer (A.1) were obtained as a light brown solid.

### I.3.2 Synthesis of Inventive Polymer (A.2), Step (γ1.2)

A 2-liter steel autoclave was charged with 100 g core (α.2) and 10 g water and then heated to 100° C. Then, 69.8 g of ethylene oxide were added within 60 minutes (0.9 mol EO/N—H). The start of an exothermic reaction was observed. The resultant mixture was allowed to react for 6 hours. Water was—together with further volatile compounds—removed at reduced pressure (20 mbar) at 80° C. An orange-colored solid (145.5 g) was obtained, of which 100 g were subjected to further ethoxylation: they were mixed in the autoclave with 3.5 g potassium hydroxide (50% by weight in water). The water was removed by heating under reduced pressure (20 mbar) to 110° C. for two hours. The autoclave was purged three times with nitrogen and then heated to 120° C. An amount of 738.7 g of EO were added within 8 hours, total amount of EO: 20 mol/N—H. The mixture was stirred at 120° C. for further 6 hours. Residual EO and water were stripped under reduced pressure (20 mbar) at 80° C. 863.0 g of inventive polymer (A.2) were obtained as a brown liquid.

### I.3.3 Synthesis of Inventive Polymer (A.3), Step (γ1.3)

A 1-1 round-bottom flask was charged with 100 g of core (α.1) and heated to 80° C. An amount of 420.65 g ε-caprolactone (2 mol/N—H) was added dropwise within 60° C. The resultant mixture was then stirred at 160° C. for 20 hours and then cooled to ambient temperature. A dark orange viscous liquid was obtained (510 g).

A 2-liter steel autoclave was charged with 105 g of the above dark orange liquid and 0.83 g of potassium methoxide in methanol. The methanol was—together with further volatile compounds—removed at reduced pressure (20 mbar) at 80° C. over a period of 2 hours. The autoclave was purged three times with nitrogen and then heated to 120° C. An amount of 308.0 g of EO were added within 6 hours, total amount of EO: 25 mol/oh. The mixture was stirred at 120° C. for further 6 hours. Residual EO and water were stripped under reduced pressure (20 mbar) at 80° C. 395.0 g of inventive polymer (A.3) were obtained as a dark brown viscous liquid.

### I.3.4 Synthesis of Inventive Polymer (A.4), Step (γ2.1)

A four-neck-round-bottom flask was charged with 190 g (polyethylene glycol) methyl ether methacrylate (average Mₙ 950 g/mol; CAS 26915-72-0; 0.200 mol) and mixed with water (180 g) and heated to 50° C. An amount of 33 g of core (α.1) in water (155 g) was added slowly and the resultant mixture was stirred at 50° C. for 13 hours. The resultant mixture was diluted with 40 g of water and cooled to ambient temperature. Then, polymer (A.4) was collected by freeze-drying. 215 g of inventive polymer (A.4) were obtained as a yellow solid. ¹H NMR analysis revealed that some 87 mol-% of the methacrylate groups had been converted.

### I.3.5 Synthesis of Inventive Polymer (A.5), Step (γ2.2)

A four-neck-round-bottom flask was charged with 416 g (polyethylene glycol) methyl ether methacrylate (average Mₙ 2000 g/mol; CAS 26915-72-0) as 50% by weight aqueous solution and mixed with additional water (50 g) and heated to 50° C. An amount of 16.7 g of core (α.1) in water (78 g) was added slowly and the resultant mixture was stirred at 80° C. for 14 hours. The resultant mixture was diluted with 80.2 g of water and cooled to ambient temperature. Then, polymer (A.5) was collected by freeze-drying. 215 g of inventive polymer (A.5) were obtained as a yellow powder. ¹H NMR analysis revealed that some 78 mol-% of the methacrylate groups had been converted.

### I.3.6 Synthesis of Inventive Polymer (A.6), Step (γ1.4)

A 2-liter steel autoclave was charged with 270 g core (α.3) in 216 g water and then heated to 100° C. The autoclave was purged three times with nitrogen and then heated to 120° C. Then, 148 g of ethylene oxide were added within 2 hours (0.9 mol EO/N—H). The start of an exothermic reaction was observed. The resultant mixture was allowed to react for 6 hours. Water was—together with further volatile compounds—removed at reduced pressure (20 mbar) at 80° C. An orange solid (416.4 g) was obtained, of which 100 g were subjected to further ethoxylation: they were mixed in the autoclave with 2.5 g potassium methoxide (32.5% by weight in methanol). The methanol was removed by heating under reduced pressure (20 mbar) to 90° C. for two hours. The autoclave was purged three times with nitrogen and then heated to 120° C. An amount of 1160 g of EO were added within 10 hours, total amount of EO: 20 mol/N—H. The mixture was stirred at 120° C. for further 6 hours. Residual EO and water were stripped under reduced pressure (20 mbar) at 90° C. 1247 g of inventive polymer (A.6) were obtained as a brown solid.

### I.3.7 Synthesis of Inventive Polymer (A.7), Step (γ1.5)

A 2-liter steel autoclave was charged with 129.0 g core (α.4) in 12.9 g water and then heated to 100° C. The autoclave was purged three times with nitrogen and then heated to 120° C. Then, 80.2 g of ethylene oxide were added within 2 hours (0.9 mol EO/N—H). The start of an exothermic reaction was observed. The resultant mixture was allowed to react for 6 hours. Water was—together with further volatile compounds—removed at reduced pressure (20 mbar) at 80° C. An orange viscous liquid (163.4 g) was obtained, of which 129.1 g were subjected to further ethoxylation: they were mixed in the autoclave with 4.3 g potassium hydroxide (50% by weight in water. The water was removed by heating under reduced pressure (20 mbar) to 110° C. for two hours. The autoclave was purged three times with nitrogen and then heated to 120° C. An amount of 1158 g of EO were added within 16 hours, total amount of EO: 20 mol/N—H. The mixture was stirred at 120° C. for further 6 hours. Residual EO and water were stripped under reduced pressure (20 mbar) at 90° C. 1319 g of inventive polymer (A.7) were obtained as a brown solid.

### II. MANUFACTURE OF INVENTIVE LAUNDRY DETERGENT COMPOSITIONS AND LAUNDERING TESTS

### II.1 Laundry Cleaning

The primary wash performance of inventive polymers was tested in Launder-O-Meter (from SDL

Atlas, Rock Hill, USA) by preparing wash solutions using water of 7° dH hardness (1.2 mmol/L; Ca:Mg:HCO₃ 4:1:8) containing 3.0 g/L of the liquid test detergent L.1, see composition in Table 1, and 3.0% of an inventive polymer (A).

TABLE 1
Ingredients of base mixture L.1 for a liquid detergent formulation

| ingredient | % by weight |
|---|---|
| Linear alkylbenzene sulfonic acid (C₁₂-C₁₄), Na salt | 5.5 |
| lauryl ether 2 EO sulphate (C.1) | 5.4 |
| C₁₂/C₁₅-fatty alcohol reacted with 7 moles of EO | 5.4 |
| Coconut C₁₂-C₁₈-alkyl fatty acid | 2.4 |
| Sodium hydroxide | 2.2 |
| 1,2 propylene glycol | 6.0 |
| ethanol | 2.0 |
| Sodium citrate | 3.0 |
| Polymer (A) | 3.0 |
| Water | to 100 |

To determine the primary detergency, the cleaning performance on 4 different particulate stains on a polyester fabric (CFT, Vlaardingen, The Netherlands) was measured by determining the color difference (delta E) between the stains after wash and the unsoiled white fabric using a reflectometer (Mach5 plus, a multi area color measurement instrument available from Colour-Consult, Beverwijk, The Netherlands). Each experiment containing the 4 different circular particulate stains (Clay ground soil, Standard clay, Red pottery clay, Tennis court clay; All 4 stains on one polyester fabric, 2 of those fabrics per wash) was repeated 4 times, and the obtained data was used to calculate the average delta E value.

By using these delta E values, the so-called “standardized cleaning performance” (delta delta E) has been calculated for each individual stain. The “standardized cleaning performance” (delta delta E) is the difference of the performance of the laundry detergent including the inventive polymer vs. the laundry detergent w/o any inventive polymer.

Table 2 shows the washing test conditions and Table 3 summarizes the obtained standardized cleaning performance. The standardized cleaning performance shown in Table 3 is the sum of the standardized cleaning performance of all 4 stains. The bigger the sum of the delta delta E value, the bigger the positive contribution of the inventive polymer vs. the laundry detergent w/o any inventive polymer on the cleaning performance.

TABLE 2
Washing conditions for evaluation of primary cleaning performance on particulate stains
Washing conditions

| Device | Launder-O-Meter from SDL Atlas, Rock Hill, USA | |
|---|---|---|
| Washing liquor | 250 | mL |
| Washing time | 30 | minutes |
| Washing temperature | 30° | C. |
| Detergent concentration | 3.0 | g/L |

| | |
|---|---|
| Water hardness (Ca:Mg:HCO₃) | 1.2 mmol/L (4:1:8) (7 °dH) |
| Fabric to liquor ratio | 1:10 |
| Inventive polymer (A) | 3% by weight (vs. liquid laundry detergent) of the |
| | polymer, 100% active ingredient |
| Test fabric * | 4 different circular particulate stains (P-H018, P- |
| | H115, P-H144, P-H145) (CFT, Vlaardingen, The |
| | Netherlands) on one polyester fabric; 2 stained |
| | fabrics per wash |
| Ballast fabric | 2.5 g SBL 2004 (Soil Ballast Fabric ‘Formula 2004’ |
| | that simulates sebum grease stains; WFK Test- |
| | gewebe GmbH, Brueggen, Germany); +additional |
| | white cotton ballast |

* After the washing experiment, the test fabrics were rinsed with tap water followed by drying at ambient room temperature overnight, prior to the measurement with the Mach5 plus.

TABLE 3
Results from washing tests (primary cleaning
performance on particulate stains).

| | Standardized cleaning performance |
|---|---|
| Polymer (A) | (sum delta delta E) |
| (A.1) | 11.3 |
| (A.3) | 7.4 |
| (A.4) | 8.5 |
| (A.5) | 7.4 |
| (A.6) | 7.2 |

Test results:

The experimental error is +/−2 delta delta E units. Therefore, any value >2 (sum delta delta E) means that the respective polymer provides a measurable and/or visible contribution to the overall cleaning performance of the respective detergent formulation; any value >4 (sum delta delta E) means that the respective polymer provides a significant contribution to the overall cleaning performance, i.e., the respective polymer leads to a significant improvement of the formulation. It can be concluded from Table 3 that all inventive polymers (A) tested exhibit significant cleaning benefits on particulate stains.

### III. Biodegradation Tests

General: the tests were carried out in accordance with the OECD Guidelines. According to the OECD guidelines a test is valid if:
1. The reference reaches 60% within 14 days.
2. The difference of the extremes of the test replicates by the end of the test is less than 20%.
3. Oxygen uptake of inoculum blank is 20 to 30 mg O₂/I and must not be greater than 60 mg O₂/I.
4. The pH value measured at the end of the test must be between 6 and 8.5.

Description of the test method used in the context of the present invention: Biodegradation in sewage was tested in triplicate using the OECD 301 F manometric respirome-try method. OECD 301 F is an aerobic test that measures biodegradation of a sewage sample by measuring the consumption of oxygen. To a measured volume of sewage, 100 mg/L test substance, which is the nominal sole source of carbon, was added along with the inoculum (aerated sludge taken from the municipal sewage treatment plant, Mannheim, Germany). This sludge was stirred in a closed flask at a constant temperature (25° C.) for 28 days. The consumption of oxygen is determined by measuring the change in pressure in the closed flask using an Oxi TopC. Carbon dioxide evolved was absorbed in a solution of sodium hydroxide. Nitrification inhibitors were added to the flask to prevent consumption of oxygen due to nitrification. The amount of oxygen taken up by the microbial population during biodegradation of the test substance (corrected for uptake by a blank inoculum run in parallel) is expressed as a percentage of ThOD (theoretical oxygen demand, which is measured by the elemental analysis of the compound). A positive control glucose/glutamic acid is run along with the test samples for each cab-inet as reference.

Calculations: Theoretical oxygen demand: Amount of O₂ required to oxidize a compound to its final oxidation products. This amount is calculated using the elemental analysis data.

### % Biodegradation

Experimental O₂ uptake×100 and divided by the theoretical oxygen demand

The results of biodegradability tests are summarized in Table 4.

TABLE 4
summary of biodegradation tests

| sample | Biodegradation [%] |
|---|---|
| (A.1) | 57 |
| (A.3) | 53 |
| (A.4) | 75 |
| (A.5) | 85 |
| (A.6) | 66 |

In each test, the reference had a biodegradability of more than 60%.

1. An aqueous composition comprising
(A) at least one polymer comprising
(a) a core formed by an aliphatic di-, tri- or tetracarboxylic acid amidated with aliphatic triamine or tetraamine wherein the amino groups are connected through C₂-C₄-alkylene groups wherein at least 50 mol-% of the C₂-C₄-alkylene groups are alkylene groups with at least three carbon atoms, and
(b) poly alkylene oxide chains linked directly to the amino groups of the core or indirectly through a spacer.

2. The composition according to claim 1, wherein said aqueous composition is a laundry detergent.

3. The composition according to claim 1, wherein said aliphatic di-, tri- or tetracarboxylic acid is selected from the group consisting of adipic acid, glutamic acid, tartaric acid, malic acid and citric acid.

4. The composition according to claim 1, additionally containing vinyl-polyethylene glycol.

5. The composition according to claim 1, wherein polymer (A) has an amine value in the range of from 10 to 100 mg KOH/g, determined according to DIN EN ISO 9702.

6. The composition according to claim 1, wherein said composition additionally comprises
(B) at least one hydrolase.

7. The composition according to claim 1, wherein said composition additionally comprises
(C) at least one anionic surfactant.

8. The composition according to claim 1, wherein the spacer is selected from the group consisting of a CH₂—CH(X¹)C═O-group, with X¹ being selected from the group consisting of hydrogen and methyl, a CH₂—C═O group, O—(CH₂)₅—C═O or O—(CH₂)₃—C═O groups, and —O—(CH₂)₅—C(═O)—O—(CH₂)₅—C(═O)— or —O—(CH₂)₃—C(═O)—O—(CH₂)₃—C(═O)— groups.

9. The composition according to claim 1, wherein said aliphatic triamines or tetraamines are selected from the group consisting of N,N′-bis(3-aminopropyl)-1,3-propanediamine, N4-amine, N3-amine and combinations of N3-amine and N4-amine.

10. The composition according to claim 1, wherein said composition comprises
(B) at least one enzyme, and
(C) at least one anionic surfactant.

11. A method of using the composition according to claim 1, the method comprising using the composition for laundry care.

12. A polymer (A) comprising
(a) a core formed by an aliphatic di-, tri- or tetracarboxylic acid amidated with aliphatic triamine or tetraamine wherein the amino groups are connected through C₂-C₄-alkylene groups wherein at least 50 mol-% of the C₂-C₄-alkylene groups are alkylene groups with at least three carbon atoms, and
(b) poly alkylene oxide chains linked directly to the amino groups of the core or indirectly through a spacer.

13. The polymer according to claim 12, having an amine value in the range of from 10 to 100 mg KOH/g, determined according to DIN EN ISO 9702.

14. The polymer according to claim 12, wherein said aliphatic di-, tri- or tetracarboxylic acid is selected from the group consisting of adipic acid, glutamic acid, tartaric acid, malic acid and citric acid.

15. The polymer according to claim 12, wherein said aliphatic triamines or tetraamines are selected from the group consisting of N,N′-bis(3-aminopropyl)-1,3-propanediamine, N4-amine, N3-amine and combinations of N3-amine and N4-amine.

16. A process for making polymers the polymer according to claim 12, comprising the steps of
(α) providing an aliphatic di-, tri- or tetracarboxylic acid or its respective C₁-C₂-alkyl ester,
(β) reacting said di-, tri- or tetracarboxylic acid or its respective C₁-C₂-alkyl ester with at least one aliphatic triamine or tetraamine, thereby forming a core (a), and
(γ) attaching polyalkylene chains to the amino groups by
(γ1) reacting core (a) with at least one C₂-C₄-alkylene oxide, in the absence or presence of a catalyst, with or without introduction of a spacer prior to alkoxylation, or
(γ2) reacting core (a) with a monoacid of poly-C₂-C₃-alkylene glycol or with its C₁-C₂-alkyl ether or with (meth)acrylic acid ester of an oligo- or polyethylene glycol or of an oligo- or polypropylene glycol or of a copolymer of ethylene oxide and propylene oxide or with a C₁-C₂-alkyl ether of any of the afore mentioned.

17. A method of improving the cleaning performance of a liquid detergent composition, the method comprising adding the polymer (A) according to claim 12 to a detergent composition that comprises at least one hydrolase (B).
